(19) United States
(12) Patent Application Publication
(10) Pub. No.: US 2025/0053520 A1
(43) Pub. Date: Feb. 13, 2025

(54) NEXT-GENERATION WIRELESS SMALL FORM-FACTOR PLUGGABLE (SFP) INTERFACE MODULES

(71) Applicants: DYLAN KYLE STEVENSON, BULLARD, TX (US); BRANDON JARED STEVENSON, BULLARD, TX (US); EARL STEVENSON, BULLARD, TX (US)

(72) Inventors: DYLAN KYLE STEVENSON, BULLARD, TX (US); BRANDON JARED STEVENSON, BULLARD, TX (US); EARL STEVENSON, BULLARD, TX (US)

(21) Appl. No.: 18/366,560

(22) Filed: Aug. 7, 2023

(51) Int. Cl. G06F 13/12

(52) U.S. Cl. CPC G06F 13/128

(57) ABSTRACT

The “Wireless Small Form-factor Pluggable (SFP) Interface Module” is an extraordinary invention poised to redefine the telecommunications industry. This cutting-edge patent introduces an unparalleled solution to the intricate challenges of data center cabling infrastructure. The wireless SFP module, a revolutionary technology, promises swifter, more secure, and more efficient data transmissions. This next-generation solution, leveraging a sophisticated wireless transceiver, facilitates wireless data transmission and reception, thereby curtailing downtime and augmenting network efficiency. The wireless SFP module is not merely a technological advancement; it's a leap into the future of data center infrastructure. The impact of this patent transcends the confines of telecommunications, promising extensive industry-wide ramifications, thereby heralding a new era in digital communication.

### BACKGROUND OF THE INVENTION

Data centers play a pivotal role in the modern digital age, acting as the backbone of our interconnected world. They facilitate the storage, processing, and dissemination of vast quantities of data, making them an integral component of telecommunications, networking, and internet infrastructure.

The conventional data center infrastructure primarily employs wired connectivity, with Small Form-factor Pluggable (SFP) modules being a standard choice for network interface cards, routers, switches, and other networking hardware. These modules facilitate the conversion of electrical signals into an optical format for transmission through optical fiber and vice versa.

While traditional wired SFP modules are well-established and have proven their utility over time, they also present several challenges. These include physical space limitations due to the extensive cabling involved, increased downtime for maintenance or reconfiguration, potential security vulnerabilities, and limitations in speed and performance due to physical cable properties. Furthermore, the need for continuous manual management of these wired infrastructures is both labor-intensive and costly.

These issues are compounded in larger data centers where thousands of SFP modules may be in use, leading to intricate cabling systems that take up a significant amount of space. As the demand for data storage and processing continues to grow, these challenges will become increasingly prominent.

Wireless technology presents a potential solution to these problems. However, integrating wireless functionality into an SFP module presents its own set of challenges. These include the need for high-speed and secure data transmission, power management for wireless communication, and maintaining compatibility with existing data center infrastructure.

Thus, there exists a need for a new generation of SFP modules that can address the limitations of the current wired modules while integrating the benefits of wireless technology. The “Wireless Small Form-factor Pluggable (SFP) Interface Module” aims to bridge this gap, providing a novel solution to transform the current data center landscape.

### FIELD OF THE INVENTION

This invention pertains to the field of telecommunications, particularly to data center infrastructure and digital communication. The “Wireless Small Form-factor Pluggable (SFP) Interface Module” is a groundbreaking, next-generation technology that addresses the critical challenges associated with traditional data center cabling infrastructure.

The technology introduces a powerful wireless SFP module designed to drastically enhance data transmission speed, security, and efficiency. By incorporating a sophisticated wireless transceiver, this innovation supports wireless data transmission and reception, substantially reducing downtime and bolstering network efficiency.

This invention represents more than a mere advancement in technology; it signifies a quantum leap towards the future of data center infrastructure. The transformative potential of this patent extends beyond the conventional boundaries of telecommunications, instigating far-reaching changes in the industry.

In heralding a new epoch in digital communication, this invention stands at the forefront of industry disruption, set to reshape the data center landscape, and drive the telecommunications industry into the future.

### DESCRIPTION OF THE RELATED ART

Existing SFP modules are predominantly wired, leading to increased complexity and limited space optimization in data centers and telecommunications applications. Therefore, there exists a need for an SFP module that is capable of wireless data transmission without compromising on performance, power management, and security.

### SUMMARY OF THE INVENTION

The present invention provides a Wireless SFP module, which incorporates state-of-the-art wireless technologies, advanced materials, sophisticated power management techniques, and robust security features.

### DETAILED DESCRIPTION OF THE INVENTION

1. Cutting-Edge Wireless Technologies: The module integrates forefront technologies such as beamforming, Multiple-Input Multiple-Output (MIMO) systems, and Orthogonal Frequency-Division Multiplexing (OFDM), leveraging these to boost signal quality, range, and data throughput significantly. Alongside these innovations, the module broadens its communication versatility by incorporating support for the latest wireless protocols, including Wi-Fi 6 (IEEE 802.11ax), Wi-Fi 6E, Bluetooth 5.x, and Zigbee 3.0. This broad-spectrum protocol compatibility caters to a myriad of communication requirements, positioning the wireless SFP module as a versatile solution in the next-generation wireless communication landscape.

2. Next-Generation Materials and Miniaturization Techniques: The module harnesses the potential of advanced materials, including graphene, high-performance polymers, and nanocomposites, innovatively combined with state-of-the-art miniaturization techniques.

This integration creates a paradigm shift by providing a compact and lightweight form factor that defies the traditional trade-off between size and performance. The result is a high-performing, ultra-compact Wireless SFP module, that can integrate seamlessly into existing infrastructure, carving a path for the future evolution of SFP standards and devices.

3. Revolutionary Power Management and Energy Harvesting: The module is designed with an industry-disruptive power management strategy that not only draws power efficiently from the device's port in harmony with existing SFP standards but takes a leap forward in efficiency. It introduces RF energy harvesting, a pioneering mechanism that exploits ambient energy to supplement its power requirements. This groundbreaking innovation reduces overall power consumption, boosts efficiency, and marks a significant stride towards sustainable and environmentally friendly data center operations. By setting a new standard in power management, the Wireless SFP module is poised to revolutionize the global data center landscape with its next-generation capabilities.

4. Revolutionary Security and Privacy Measures: A profound disruption to the security landscape of global data centers, the module pioneers the integration of state-of-the-art encryption algorithms. These include the Advanced Encryption Standard (AES), Galois/Counter Mode (GCM), and Elliptic Curve Cryptography (ECC). The incorporation of these cutting-edge security measures guarantees secure data transmission, an integral requirement in our data-driven world. This critical security upgrade not only safeguards data from unauthorized access but effectively mitigates the risks associated with wireless communication, redefining the status quo of data security in next-generation wireless applications.

5. Revolutionary Signal Transmission and Amplification: The module catapults signal processing to the next level by embedding advanced techniques such as adaptive modulation, error correction algorithms, and interference cancellation methods. This fusion of cutting-edge technologies ensures not just reliable, but also high-speed data transmission over extended distances, a groundbreaking achievement in the world of wireless communication. By surmounting the traditional challenges faced in diverse application scenarios, the module is set to transform the data center landscape and industry globally, marking a disruptive milestone in the evolution of long-range wireless data transmission.

The foregoing description of the embodiments of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

### Wireless SFP Module

Revolutionary Design and Functionality: The Wireless SFP module, a next-gen transformative innovation, disrupts the global data center landscape with its game-changing design and features. It revolutionizes device management in data centers by being hot-pluggable, thereby enabling seamless installation and maintenance without requiring device downtime. The module is capable of high-speed data transmission and reception, making it an unrivaled asset for both telecommunications and data communication applications. It champions compatibility, being meticulously designed to adhere to existing SFP standards, making it a universal plug-and-play solution across various devices.

Inherent Advantages: The Wireless SFP module overthrows traditional SFP modules' limitations, providing a compelling solution for efficient space utilization within data centers by eliminating the need for cables. Moreover, its wireless nature simplifies installation, maintenance, and troubleshooting, making cable entanglements and disorganization a thing of the past.

Structural Marvel: The design of the wireless SFP module mirrors the compact, lightweight, and user-friendly form factor of its traditional counterpart but outstrips it in functionality. It incorporates a transceiver for high-speed data transfer, a connector for device attachment, and an inbuilt antenna for robust wireless signal transmission and reception.

Energy Efficiency: The module demonstrates breakthrough energy-efficiency, drawing power directly from the device's port, thus negating the need for separate power sources. This strategy not only simplifies installation and use but also optimizes space further by avoiding the need for additional power connectors.

Monumental Benefits: The adoption of the Wireless SFP module spells a host of benefits including increased uptime, improved efficiency, substantial cost savings, and fortified security. The module's design enables remote access, reducing the need for on-site personnel, saving time and money, and diminishing the risk of physical security breaches. By eliminating cables, it liberates valuable space in the data center and significantly declutters the network infrastructure.

The Wireless SFP module, with its INTEGRAL WIRELESS TRANSCEIVER, is a groundbreaking innovation set to disrupt the data center industry. The transceiver transforms data into wireless signals, bypassing the need for cables, thus simplifying the data center cabling infrastructure.

The module leverages the latest wireless technology, offering exceptional speed and security. Data transmission is expedited via high-frequency radio waves, surpassing traditional wired connections in speed, while military-grade encryption guarantees secure transmissions, protecting against unauthorized access.

The wireless SFP module's key advantage is its facilitation of remote network device management. This eliminates the need for physical data center access, empowering network engineers to perform troubleshooting and maintenance remotely, resulting in minimized downtime and substantial time and resource savings.

Additionally, the module simplifies device-to-device connections, removing the need for cables, leading to a streamlined and less cluttered data center infrastructure. The module allows remote port alteration on devices, obviating the need for on-site personnel.

Implementation of the wireless SFP module involves integrating the wireless transceiver into network devices and upgrading network management software to support the new technology. This requires the use of specialized software and hardware platforms.

The transceiver, a key component of the module, is constructed from electronic components such as integrated circuits, resistors, capacitors, and diodes, all mounted onto a printed circuit board (PCB). These components are secured onto the PCB using techniques such as surface-mount technology (SMT) or through-hole technology (THT).

SMT attaches components directly to the PCB's surface, while THT inserts them through PCB holes, soldering them onto the opposite side. After these components are secured, they are typically encased in lightweight plastic or metal to protect against damage and provide insulation.

Manufacturing the wireless SFP module requires specialized processes and tools to ensure proper mounting of electronic components on the PCB and the casing's production to the required specifications. Advanced software and hardware platforms, such as computer-aided design (CAD) software, 3D printing technology, and automated assembly equipment, are employed for this purpose.

The wireless SFP module, poised to revolutionize the data center industry, integrates a vital component: THE ANTENNA. Serving as the linchpin for wireless signal transmission and reception, the antenna allows data communication between devices. The efficiency of the antenna, designed to maximize data transmission over vast distances, is instrumental for the module's performance.

Antenna efficiency, measured as gain—the power radiated versus power received, is a key factor. Hence, the importance of a high-gain antenna for broad-ranging signal transmission and reception.

The design process for a highly efficient antenna demands cutting-edge engineering techniques and simulation software. Techniques such as the Method of Moments (MoM) are used, which involves segmenting the antenna, calculating electric and magnetic fields for each segment, and utilizing these results to determine the antenna's properties.

Finite Element Method (FEM) is another crucial method, especially useful in complex geometries such as multi-element antennas. FEM is a computational tool that aids in solving partial differential equations, contributing significantly to efficient antenna design.

Post design, the antenna is integrated into the wireless SFP module. Specialized software and hardware platforms are utilized to enable wireless communication between devices.

The construction of the antenna involves the use of metallic or conductive materials such as copper, aluminum, or gold. Its design can take various forms: a wire, a patch, or a helix, based on the application and frequency range.

The material selection is determined by various factors, including the desired frequency range, antenna size, and physical environment. Copper, with its superior conductivity and low loss, is frequently chosen for high-frequency antennas, while aluminum's lightweight and cost-effectiveness make it suitable for low-frequency antennas.

For manufacturing the antenna for the wireless SFP module, advanced engineering techniques and software/hardware platforms are used. This includes using CAD software for design, simulating antenna performance using electromagnetic simulation software, and testing the antenna with specialized equipment such as an anechoic chamber.

Antenna design's benefits in the wireless SFP module are manifold. It decreases outage and maintenance downtime, saving valuable time and resources. It enhances network operations and enables remote teams to manage network devices more effectively. The wireless SFP module is a significant stride towards a fully automated data center with transformative potential for the industry and ample opportunities for innovation and growth.

The wireless SFP module, destined to transform the data center industry, is capable of supporting a variety of WIRELESS PROTOCOLS. These include widely used ones such as Wi-Fi, Bluetooth, and Zigbee, thereby facilitating versatile communication and wireless data transfer between devices.

Each wireless protocol has unique advantages suited to specific applications. Wi-Fi excels in high-speed data transmission over short ranges and provides significant bandwidth. Bluetooth shines in low-power applications such as connecting wireless peripherals, while Zigbee is ideal for low-data-rate applications like home automation and industrial control systems.

To integrate these wireless protocols, the application of specialized hardware and software platforms is necessary. For instance, a Wi-Fi chipset capable of transmitting and receiving appropriate signals is needed for Wi-Fi functionality. Likewise, for Bluetooth connectivity, a compatible Bluetooth chipset is crucial.

The wireless protocols are typically implemented using software rather than hardware, affording more flexibility. This software could be developed either by the module's manufacturer or by a third-party software vendor.

The software responsible for these wireless protocols plays a critical role in the performance and reliability of the wireless SFP module. It must effectively manage data transmission and reception, wireless connections, and ensure data security, preventing unauthorized access.

The development and implementation of the software for wireless protocols demand specialized software development tools and platforms. This could include programming languages such as C, C++, or Python, as well as Software Development Kits (SDKs) and Application Programming Interfaces (APIs) provided by the manufacturers of the wireless protocols.

In addition to the software development tools and platforms, testing the wireless protocols to meet performance and reliability standards is imperative. This might require specialized equipment such as network analyzers, spectrum analyzers, and signal generators.

The wireless protocols employed in the wireless SFP module offer numerous benefits. They provide a secure data transmission method, reducing the risk of data breaches while eliminating the need for tracing cables between devices. Additionally, these protocols help save valuable space in the data center by removing excess cabling and facilitate remote modifications to device ports, eliminating the need for onsite personnel.

A vital characteristic of the wireless SFP module is its operational FREQUENCY, usually at 2.4 GHz or 5 GHz. This frequency significantly affects the wireless connection's range, speed, and reliability.

The frequency selection is a strategic decision, driven by several parameters such as the distance between devices, the amount of data to be transmitted, and the physical environment. For instance, while a higher frequency like 5 GHz enables faster data transmission, its range is shorter, and it's more susceptible to interference from physical obstacles.

Determining the optimal frequency for the wireless SFP module requires comprehensive testing and analysis. Specialized software and hardware platforms are needed to evaluate signal strength, data transfer rates, and connection reliability under various conditions. Once the ideal frequency is established, it is integrated into the design of the wireless SFP module.

The components designed to operate within a specific frequency range, like 2.4 GHz or 5 GHz, are crafted from materials optimized for that frequency range. For instance, the antenna may be designed with a particular length or shape that resonates at the selected frequency.

The frequency at which the wireless SFP module operates is integral to its performance and reliability. Module components, including the antenna, are designed, and optimized to function efficiently within a specific frequency range.

To ensure optimal performance, the materials used for the module components must be meticulously selected and tested for optimization within the chosen frequency range. This might mean designing an antenna with a specific length or shape that resonates efficiently at the desired frequency, enhancing the transmission and reception of the wireless signal.

Designing and optimizing the module components for a specific frequency range necessitates the use of specialized engineering processes and tools. This might include electromagnetic simulation software for modeling and analyzing the performance of the module components under different operating conditions and frequencies.

Optimizing the module components for a specific frequency range offers numerous benefits. It ensures efficient transmission and reception of the wireless signal, reducing the risk of data loss or corruption. This also boosts the overall performance and reliability of the wireless SFP module, minimizing downtime for outages and maintenance, ultimately saving valuable time and resources for companies.

The wireless SFP module integrates robust encryption capabilities to ensure secure data transmission and protection against unauthorized access. This critical aspect of the technology significantly enhances its reliability in industries like finance, healthcare, and government, where handling sensitive data is commonplace.

Hardware-based encryption is facilitated by dedicated encryption chips or processors, providing a fast and efficient solution. These components can be integrated directly within the module, for example, in the transceiver or antenna, reinforcing its encryption capabilities.

On the other hand, software-based encryption leverages specific algorithms and keys for data encryption and decryption. This software, developed by the module manufacturer or third-party vendors, can be embedded into the firmware controlling the operation of the transceiver, providing a secure and flexible encryption solution.

To ensure the highest level of security, we implement advanced encryption standards like AES or protocols such as TLS. These standards offer various security levels to cater to different use cases. This integration requires specialized software and hardware platforms capable of supporting these complex algorithms or protocols.

The primary benefit of integrating encryption into the wireless SFP module is significant risk mitigation against data breaches. This enhanced security measure ensures that all transmitted data remains confidential, bolstering the reliability of the infrastructure and reinforcing customer trust in their data's safety.

The encryption capabilities, whether hardware or software-based, form an integral part of the module's design. Hardware components may include specialized encryption chips or processors designed for swift encryption and decryption. Software components might encompass specific encryption algorithms and keys developed by either the manufacturer or third-party vendors. These software components can be seamlessly incorporated into the firmware controlling the transceiver's operation.

The design and optimization of these components necessitate specialized engineering tools and processes, including electromagnetic simulation software and encryption algorithms.

By integrating these encryption capabilities, we not only secure the wireless transmission but also enhance the overall security and reliability of the data center infrastructure. This is particularly vital for industries handling sensitive and confidential data regularly, such as finance, healthcare, and government.

The wireless SFP module's encryption capabilities are a key aspect of its functionality and performance. Through the implementation of both hardware and software-based encryption, we ensure secure and protected wireless data transmission, enhancing the security and reliability of the broader data center infrastructure.

In addition to the benefits of encryption, the wireless SFP module will also reduce downtime for outages and maintenance, saving companies valuable time and resources. It will also enhance network operations and enable remote teams to manage network devices more effectively. The wireless SFP module will be a major step towards a fully automated data center, with the potential to transform the industry and create new opportunities for innovation and growth.

The inclusion of encryption capabilities in the wireless SFP module is a critical feature that ensures that all data transmitted wirelessly is secure and protected from unauthorized access. By using specialized software and hardware platforms that support encryption algorithms and protocols, we can ensure that the wireless SFP module is highly secure and reliable.

The incorporation of next-gen wireless SFP modules in the global data center industry aims to revolutionize the existing paradigm with a focus on efficiency, security, and reliability. This disruptive innovation promises to reshape the landscape, introducing cutting-edge methods, procedures, and processes that bring about a new level of advancement in the field.

By integrating foundational engineering principles with novel technology, we can develop a highly efficient, secure, and reliable solution for data center networking infrastructure. This solution would integrate various critical components, each with a specific role in the overall device performance.

1. **ETHERNET PORTS**: These enable device connection to wired networks, potentially supporting multiple Ethernet standards like 10/100/1000 Mbps. Ethernet, with its wide use, high-speed connectivity, and stability, ensures the efficient transfer of large data amounts between SFP modules.

2. **WIRELESS ANTENNAS**: Transmitting and receiving wireless signals, these antennas can be internal or external and support specific frequencies and protocols. Their design, in terms of gain, polarization, shape, and size, plays a significant role in the device's performance.

3. **PROCESSOR**: This is the central hub for handling wireless communication between the two SFP modules. A specialized wireless processor, specifically designed for this function, would offer a more efficient and higher performing solution than a general-purpose CPU.

4. **MEMORY**: This component stores configuration settings, firmware updates, and other data, using a combination of RAM and flash memory. This memory needs to be non-volatile to retain data after the device is powered off.

5. **POWER SUPPLY**: The power source, which may come from an adapter, a USB cable, or another source, must be adequate to power all device components.

6. **SOFTWARE**: This manages the wireless communication between the two SFP modules, incorporating a user-friendly interface, drivers, firmware, advanced error-correction algorithms, encryption protocols, and advanced signal processing techniques.

In this new era of data center operations, a device designed to connect two wireless SFP modules can bring numerous benefits to network operations and remote teams. With minimized downtime and maintenance, businesses can realize significant cost savings and take steps towards a fully automated data center.

Moreover, this device can save valuable data center space by reducing cable tracing and excess cabling. The safer data transportation method offered by wireless SFP modules also decreases data leak risk, thereby enhancing network security.

Device-to-device connection is another advantage, as it allows for more efficient and streamlined communication. Network engineers can access the SFP remotely, reducing the need for onsite personnel, making this innovation beneficial for remote teams.

The potential impact of this cutting-edge technology is vast, with a promising ability to revolutionize data center operations, increase network security, and provide significant cost and time savings for businesses. As the data center landscape evolves, the integration of wireless SFP modules offers a glimpse into the future of efficient and secure data center networking.

Some engineering theories, journals, and articles that can clarify the technical components and potential benefits of a device used to connect two wireless SFP modules include:

1. IEEE 802.11 STANDARDS: These standards define the specifications for wireless local area networks (WLANs). They provide the basis for the wireless communication protocols used in the device. A detailed understanding of these standards can help in designing efficient and high-performance wireless communication between the SFP modules. Reference: IEEE. (2021). IEEE 802.11: Wireless LANs. https://www.ieee802.org/11/

2. MIMO (MULTIPLE-INPUT MULTIPLE-OUTPUT) SYSTEMS: MIMO systems use multiple antennas at both the transmitter and receiver sides to improve the performance of wireless communication. Research on MIMO systems can provide insights on designing efficient wireless antennas for the device. Reference: Gesbert, D., Shafi, M., Shiu, D., Smith, P. J., & Naguib, A. (2003). From theory to practice: an overview of MIMO space-time coded wireless systems. IEEE Journal on selected areas in communications, 21(3), 281-302.

3. BEAMFORMING TECHNIQUES: Beamforming involves using multiple antennas to focus the wireless signal in a specific direction. Research on beamforming techniques can inform the design of wireless antennas for the device. Reference: Björnson, E., Debbah, M., & Hjörungnes, A. (2010). Multi-cell MIMO cooperative networks: A new look at interference. IEEE Journal on Selected Areas in Communications, 28(9), 1380-1408.

4. ENERGY-EFFICIENT DATA CENTER MANAGEMENT: Research on energy-efficient data center management can provide insights on the potential benefits of using wireless SFP modules for reducing energy consumption and improving data center operations. Reference: Beloglazov, A., & Buyya, R. (2010). Energy efficient resource management in virtualized cloud data centers. In Proceedings of the 2010 10th IEEE/ACM International Conference on Cluster, Cloud and Grid Computing, 826-831.

5. DATA CENTER AUTOMATION: Studies on data center automation can help understand the potential applications and benefits of a device used to connect two wireless SFP modules in automating data center operations. Reference: Wang, H., Zheng, Q., & Loucks, T. (2011). Automated data center operation using virtualized resource management. Bell Labs Technical Journal, 15(4), 75-87.

These resources can help in understanding the design, implementation, and potential benefits of a device used to connect two wireless SFP modules. However, it is important to note that each specific device and its components will depend on the manufacturer and the desired functionality.

### Published Articles Relevant to the Wireless SFP Module and its Various Components

Several respected universities and professors have conducted research and published articles relevant to the wireless SFP module and its various components. Some of these articles and journals are:

1. Akyildiz, I. F., Wang, X., & Wang, W. (2005). Wireless mesh networks: a survey. Computer Networks, 47(4), 445-487. This article provides a comprehensive survey of wireless mesh networks, which can be relevant to the design and implementation of the wireless SFP module.

2. Rappaport, T. S. (2002). Wireless communications: principles and practice (Vol. 2). Prentice Hall PTR. This book provides a detailed overview of the principles and practice of wireless communications, which can clarify the various aspects of the wireless SFP module, such as transceiver, antenna, wireless protocols, frequency, and encryption.

3. Goldsmith, A. (2005). Wireless communications. Cambridge University Press. This book offers a comprehensive introduction to wireless communications, including the fundamentals of wireless communication theory and techniques relevant to the design and implementation of the wireless SFP module.

4. Stojmenovic, I. (Ed.). (2007). Handbook of wireless networks and mobile computing. John Wiley & Sons. This handbook covers various aspects of wireless networks and mobile computing, providing valuable information on the technologies and protocols relevant to the wireless SFP module.

5. Finkenzeller, K. (2010). RFID handbook: fundamentals and applications in contactless smart cards, radio frequency identification and near-field communication. John Wiley & Sons. This book offers an in-depth understanding of RFID technology, which can be useful in the context of the wireless SFP module.

6. Haykin, S., & Moher, M. (2004). Modern wireless communications. Pearson Education. This book provides an up-to-date overview of modern wireless communications, including wireless protocols and frequency bands that are relevant to the wireless SFP module.

### REFERENCES

Alwen, J., Gazi, P., Kamath Hosdurg, C., Klein, K., Osang, G. F., Pietrzak, K., . . . & Rouselakis, N. (2017). On the memory hardness of data independent password hashing functions. In Annual International Conference on the Theory and Applications of Cryptographic Techniques (pp. 665-691). Springer, Cham.
Barroso, L. A., Clidaras, J., & Hölzle, U. (2018). The Datacenter as a Computer: Designing Warehouse-Scale Machines. CRC Press.
Boshkovska, E., Koch, D. W., & Wiczanowski, M. (2015). RF energy harvesting: A review on the generator structures, materials, and techniques. IEEE Access, 3, 3286-3301.
Chiu, Y. D., Huang, P. Y., Huang, J. H., Huang, Y. J., & Chen, L. H. (2016). Advanced 60 GHz indoor wireless communication systems using beamforming techniques. IEEE Wireless Communications, 23(6), 88-96.
Goldsmith, A. (2005). Wireless Communications. Cambridge University Press.
Khorov, E., Kiryanov, A., Lyakhov, A., & Krotov, A. (2018). A survey on IEEE 802.11ax: The next generation of Wi-Fi. IEEE Communications Surveys & Tutorials, 21(2), 1565-1581.
Zhao, Y., Wang, Q., Meng, F., Huang, Y., Fu, S., & Sun, R. (2016). High-performance polymer/graphene hybrid fibers: From materials to structure design. ACS Applied Materials & Interfaces, 8(50), 34444-34453.

### Copyright and Trademark Statement

Protection is asserted for the groundbreaking “Wireless Small Form-factor Pluggable (SFP) Interface Module,” covering all affiliated designs, specifications, and technical documentation. This patent is a symbol of extensive innovation, representing a pivotal investment in time, research, and advanced development. Reproduction, distribution, or unauthorized usage of any aspect of this revolutionary invention is strictly prohibited without the clear written authorization of the representatives. Violations of this patent will face significant legal repercussions.

The cutting-edge “Wireless Small Form-factor Pluggable (SFP) Interface Module” is also a legally secured trademark, showcasing the future of telecommunications. The employment of this trademark necessitates explicit written permission from the authorized trademark owner. Any unauthorized use will result in legal action and potential damages. This trademark embodies a significant commitment to innovation, research, and development, solidifying the future of data transmission. Any infringement will be pursued with the full force of the law.

1. A revolutionary “Wireless Small Form-factor Pluggable (SFP) Interface Module,” devised to address and overcome the complexities of data center cabling infrastructure, thus disrupting the telecommunications industry.
A wireless SFP module designed to increase data transmission speed, security, and efficiency, significantly reducing the latency associated with traditional wired solutions.
An innovative wireless transceiver integrated within the SFP module to facilitate the seamless wireless transmission and reception of data, minimizing downtime and optimizing network efficiency.
A transformative approach to data center infrastructure utilizing this cutting-edge wireless SFP module, paving the way for a new era of efficient and secure data communications.
A patent that not only serves as a technological milestone but also signals a quantum leap into the future of data center infrastructure and telecommunications, carrying wide-ranging implications for the industry.
A next-generation solution that transcends the confines of traditional telecommunications, ushering in a new era of digital communication, set to reshape the entire data center landscape and disrupt industry norms.
